(19) United States
(12) Patent Application Publication
(10) Pub. No.: US 2019/0234454 A1
(43) Pub. Date: Aug. 1, 2019

(54) Pump Apparatus and Brake Apparatus

(71) Applicant: Hitachi Automotive Systems, Ltd., Hitachinaka-shi, Ibaraki (JP)

(72) Inventors: Atsuki OOHIRA, Utsunomiya-shi, Tochigi (JP); Masaki MISUNO, Atsugi-shi, Kanagawa (JP); Chiharu NAKAZAWA, Kawasaki-shi, Kanagawa (JP)

(21) Appl. No.: 16/340,906

(22) PCT Filed: Sep. 15, 2017
(86) PCT No.: PCT/JP2017/033460

§ 371 Date: Apr. 10, 2019

(30) Foreign Application Priority Data
Oct. 12, 2016 (JP) 2016-200571

(51) Int. Cl. F16C 3/18; F16H 53/02; B60T 8/40; F04B 9/04

(52) U.S. Cl. CPC F16C 3/18; F16H 53/025; F04B 9/042; F04B 9/045; B60T 8/4031

(57) ABSTRACT

A plunger pump having improved durability without leading to a reduction in productivity is provided. A pump apparatus includes a sliding portion provided between a stopper portion and an eccentric cam in a direction of an eccentric central axis and having a lower frictional coefficient between the sliding portion and the eccentric cam than a frictional coefficient between the stopper portion and the eccentric cam.

### TECHNICAL FIELD

The present invention relates to a plunger pump and a brake apparatus including the plunger pump.

### BACKGROUND ART

Conventional pump apparatuses come in various types, and one known example of them is a pump apparatus disclosed in PTL 1, which will be listed below. An outline thereof will be described now. This pump apparatus employs a member shaped in such a manner that one axial side of a needle bearing is closed as an eccentric cam for driving the plunger pump, and is configured in such a manner that the closed portion is in point contact with a ball provided in a bottom portion of an eccentric cam containing chamber.

### CITATION LIST

### Patent Literature

[PTL 1] Japanese Translation of PCT International Application Publication No. 2006-514215

### SUMMARY OF INVENTION

### Technical Problem

However, in PTL 1, the ball is embedded in the bottom portion of the cam containing chamber, which necessitates securement of a space on a housing side, thereby raising a concern with an increase in a size of the apparatus. Further, a shaft and the bearing are not fixed, which also raises a concern with deterioration in assemblability. In other words, PTL 1 focuses on wear resistance to improve durability of the plunger pump, but may reduce productivity due to that.

An object of the present invention is to provide a pump apparatus and a brake apparatus that improve the durability without leading to the reduction in the productivity.

### Solution to Problem

According to one aspect of the present invention, a pump apparatus includes a sliding portion provided between a stopper portion and an eccentric cam in a direction of an eccentric central axis and having a lower frictional coefficient between the sliding portion and the eccentric cam than a frictional coefficient between the stopper portion and the eccentric cam.

Therefore, the durability of the plunger pump can be improved without leading to the reduction in the productivity.

### BRIEF DESCRIPTION OF DRAWINGS

FIG. 1 illustrates a brake apparatus according to a first embodiment.

FIG. 2 is a cross-sectional view of a plunger pump according to the first embodiment.

FIG. 3 is an enlarged cross-sectional view of a pump portion according to the first embodiment.

FIG. 4 is an exploded perspective view of a rotational driving shaft, a cam (a cam unit), a driving member (a cam unit), and a resin collar according to the first embodiment.

FIG. 5 is a cross-sectional view of the rotational driving shaft, the cam (the cam unit), the driving member (the cam unit), and the resin collar in a state mounted in a housing according to the first embodiment.

FIG. 6 is a cross-sectional view of the first embodiment taken along a line A-A in FIG. 5.

FIG. 7 illustrates a characteristic indicating a relationship between a material and a frictional coefficient according to the first embodiment.

FIG. 8 is a cross-sectional view of the rotational driving shaft, the cam (the cam unit), the driving member (the cam unit), and the resin collar in the state mounted in the housing according to a second embodiment.

FIG. 9 is an exploded perspective view of the rotational driving shaft, the cam (the cam unit), the driving member (the cam unit), a resin collar, and a metallic stopper member according to a third embodiment.

FIG. 10 is a cross-sectional view of the rotational driving shaft, the cam (the cam unit), the driving member (the cam unit), the resin collar, and the metallic stopper member in an assembled state according to the third embodiment.

FIG. 11 is an exploded perspective view of the rotational driving shaft, the cam (the cam unit), the driving member (the cam unit), a resin collar, and a metallic stopper member according to a fourth embodiment.

FIG. 12 is a cross-sectional view of the rotational driving shaft, the cam (the cam unit), the driving member (the cam unit), the resin collar, and the metallic stopper member in an assembled state according to the fourth embodiment.

FIG. 13 is a plan view of the rotational driving shaft, the cam (the cam unit), the driving member (the cam unit), the resin collar, and the metallic stopper member in the assembled state according to the fourth embodiment.

FIG. 14 is a plan view of the rotational driving shaft, the cam (the cam unit), the driving member (the cam unit), a resin collar, and the metallic stopper member in an assembled state according to a fifth embodiment.

### DESCRIPTION OF EMBODIMENTS

### First Embodiment

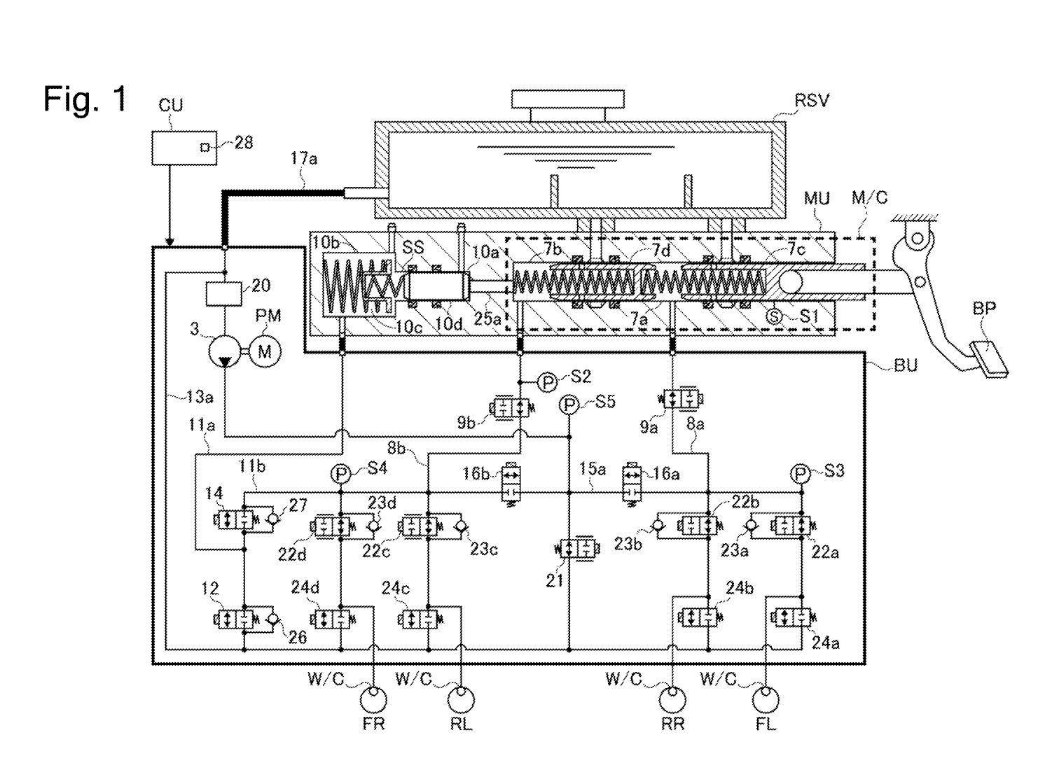

FIG. 1 illustrates a brake apparatus according to a first embodiment. The brake apparatus according to the first embodiment includes a brake pedal BP, a master cylinder unit MU, a valve unit BU, a reservoir tank RSV, and a control unit CU. The master cylinder unit MU and the valve unit BU are configured as different members from each other, and these units form a plurality of oil passages 8a, 8b, and 11a by being assembled to each other with use of a bolt. A connection between these units is not limited to a configuration directly connecting housings thereof, and may be established via a metallic pipe or the like therebetween.

The master cylinder unit MU includes a stroke sensor S1, which detects a brake operation amount input by a driver (a stroke of the brake pedal BP). The master cylinder unit MU includes a master cylinder M/C and a stroke simulator SS. The master cylinder M/C includes a primary fluid chamber 7a and a secondary fluid chamber 7b, and brake fluid is supplied from the reservoir tank RSV to each of them. When the brake pedal BP is pressed, the brake fluid is output from the primary fluid chamber 7a to a primary system via a primary piston 7c. At the same time, the brake fluid is output from the secondary fluid chamber 7b to a secondary system via a secondary piston 7d. The primary fluid chamber 7a is connected to each of wheel cylinders W/C for a front left wheel FL and a rear right wheel RR via the oil passage 8a. The secondary fluid chamber 7b is connected to each of wheel cylinders W/C for a rear left wheel RL and a front right wheel FR via the oil passage 8b.

A primary system pressure sensor S3, which detects a primary system pressure, is provided in the oil passage 8a. A secondary system pressure sensor S4, which detects a secondary system pressure, is provided in the oil passage 8b. A primary cut valve 9a is provided in the oil passage 8a. The primary cut valve 9a blocks the communication between the primary fluid chamber 7a and the wheel cylinders W/C. Further, a secondary cut valve 9b is provided in the oil passage 8b. The secondary cut valve 9b blocks the communication between the secondary fluid chamber 7b and the wheel cylinders W/C. Both the primary cut valve 9a and the secondary cut valve 9b are normally-opened electromagnetic valves.

A positive pressure chamber 10a and a back-pressure chamber 10b of the stroke simulator SS are liquid-tightly divided, and are configured not to allow the brake fluid to travel therebetween. The positive pressure chamber 10a is connected to an oil passage 25a. The oil passage 25a is connected to the secondary fluid chamber 7b. A master pressure sensor S2, which detects a master pressure, is provided in the oil passage 8b on an upstream side of the secondary cut valve 9b. The stroke simulator SS includes a spring 10c in the back-pressure chamber 10b, and generates an operation reaction force on the brake pedal BP according to a stroke of a piston 10d. The back-pressure chamber 10b is connected to an oil passage 13a via the oil passage 11a, and is also connected to the oil passage 8b via the oil passage 11a and an oil passage 11b. A stroke simulator OUT valve (a stroke simulator adjustment valve) 12 is provided in the oil passage 11a. A stroke simulator IN valve 14 is provided in the oil passage 11b.

Both the stroke simulator OUT valve 12 and the stroke simulator IN valve 14 are normally-closed electromagnetic valves. Further, a check valve 26 is provided in parallel with the stroke simulator OUT valve 12. The check valve 26 permits an outflow of the brake fluid to the oil passage 11a when a pressure in the oil passage 11a is lower than a pressure in the oil passage 13a. Further, a check valve 27 is provided in parallel with the stroke simulator IN valve 14. The check valve 27 permits an outflow of the brake fluid to an oil passage 15a when a pressure in the oil passage 15a is lower than the pressure in the oil passage 11a. A primary communication valve 16a is provided between the oil passage 8a and the oil passage 15a. The primary communication valve 16a can switch communication/non-communication between the primary system and a pump discharge system. Further, a secondary communication valve 16b is provided between the oil passage 8b and the oil passage 15a. The secondary communication valve 16b can switch communication/non-communication between the secondary system and the pump discharge system. Both the primary communication valve 16a and the secondary communication valve 16b are normally-closed electromagnetic valves. A pump pressure sensor S5, which detects a pump discharge pressure, is provided in the oil passage 15a.

The valve unit BU includes a pump motor PM, which is a brushed motor. The pump motor PM drives a plunger pump 3 to discharge the brake fluid introduced from the reservoir tank RSV via an oil passage 17a to the oil passage 15a. A fluid pool 20 is provided on an intake side of the plunger pump 3 in the housing of the valve unit BU. Even at the time of such a failure that the brake fluid leaks out from the oil passage 17a, the brake apparatus can continue control of increasing/reducing wheel cylinder hydraulic pressures by causing the fluid pool 20 to function as a source supplying the brake fluid (to the plunger pump 3), a destination to which the brake fluid is discharged (from the wheel cylinders W/C), or the like.

A pressure adjustment valve 21 is provided between the oil passage 15a and the oil passage 13a, and an extra amount of the brake fluid discharged from the plunger pump 3 can be returned to the reservoir tank RSV via the oil passage 13a. The pressure adjustment valve 21 is a normally-opened electromagnetic valve, but may be a normally-closed electromagnetic valve.

A front left wheel pressure increase valve 22a is provided between the oil passage 8a and the wheel cylinder W/C (FL). The front left wheel pressure increase valve 22a adjusts the brake fluid flowing from the oil passage 8a to the wheel cylinder W/C (FL). Further, a check valve 23a is provided in parallel with the front left wheel pressure increase valve 22a. The check valve 23a permits an outflow of the brake fluid to the oil passage 8a when a pressure in the oil passage 8a is lower than the pressure in the wheel cylinder W/C (FL). A front left wheel pressure reduction valve 24a is provided between the wheel cylinder W/C (FL) and the oil passage 13a. The front left wheel pressure reduction valve 24a reduces the pressure in the wheel cylinder W/C (FL).

A rear right wheel pressure increase valve 22b is provided between the oil passage 8a and the wheel cylinder W/C (RR). The rear right wheel pressure increase valve 22b adjusts the brake fluid flowing from the oil passage 8a to the wheel cylinder W/C (RR). Further, a check valve 23b is provided in parallel with the rear right wheel pressure increase valve 22b. The check valve 23b permits an outflow of the brake fluid to the oil passage 8a when the pressure in the oil passage 8a is lower than the pressure in the wheel cylinder W/C (RR). A rear right wheel pressure reduction valve 24b is provided between the wheel cylinder W/C (RR) and the oil passage 13a. The rear right wheel pressure reduction valve 24b reduces the pressure in the wheel cylinder W/C (RR).

A rear left wheel pressure increase valve 22c is provided between the oil passage 8b and the wheel cylinder W/C (RL). The rear left wheel pressure increase valve 22c adjusts the brake fluid flowing from the oil passage 8b to the wheel cylinder W/C (RL). Further, a check valve 23c is provided in parallel with the rear left wheel pressure increase valve 22c. The check valve 23c permits an outflow of the brake fluid to the oil passage 8b when a pressure in the oil passage 8b is lower than the pressure in the wheel cylinder W/C (RL). A rear left wheel pressure reduction valve 24c is provided between the wheel cylinder W/C (RL) and the oil passage 13a. The rear left wheel pressure reduction valve 24c reduces the pressure in the wheel cylinder W/C (RL).

A front right wheel pressure increase valve 22d is provided between the oil passage 8b and the wheel cylinder W/C (FR). The front right wheel pressure increase valve 22d adjusts the brake fluid flowing from the oil passage 8b to the wheel cylinder W/C (FR). Further, a check valve 23d is provided in parallel with the front right wheel pressure increase valve 22d. The check valve 23d permits an outflow of the brake fluid to the oil passage 8b when the pressure in the oil passage 8b is lower than the pressure in the wheel cylinder W/C (FR). A front right wheel pressure reduction valve 24d is provided between the wheel cylinder W/C (FR) and the oil passage 13a. The front right wheel pressure reduction valve 24d reduces the pressure in the wheel cylinder W/C (FR).

All of these pressure increase valves 22a, 22b, 22c, and 22d are normally-opened electromagnetic valves, and all of these pressure reduction valves 24a, 24b, 24c, and 24d are normally-closed electromagnetic valves.

At the time of normal braking, which generates a braking force on each of the wheels according to the brake operation amount input by the driver, the control unit CU controls the primary cut valve 9a and the secondary cut valve 9b in valve-closing directions, controls the stroke simulator IN valve 14 in a valve-closing direction, controls the stroke simulator OUT valve 12 in a valve-opening direction, controls the primary communication valve 16a and the secondary communication valve 16b in valve-opening directions, and controls the pressure adjustment valve 21 in a valve-closing direction, and activates the pump motor PM. This operation allows desired brake fluid to be transmitted from the reservoir tank RSV to each of the wheel cylinders W/C via the oil passage 17a, the plunger pump 3, the oil passage 15a, and the oil passage 8a and the oil passage 8b. At this time, a desired braking force can be acquired by controlling the rotation of the motor of the pump motor PM and the pressure adjustment valve 21 so as to achieve target pressures by feeding back the values detected by the primary system pressure sensor S3, the secondary system pressure sensor S4, and the pump pressure sensor S5. Further, the brake fluid transmitted from the secondary fluid chamber 7b of the master cylinder M/C is introduced to the positive pressure chamber 10a of the stroke simulator SS to cause the piston 10d to move, by which a reaction force is applied to the spring 10c and a reaction force is generated according to the brake pedal operation. Therefore, the brake apparatus can generate the appropriate braking force, the reaction force of the brake pedal BP, and the stroke, when the braking operation is performed.

In the first embodiment, the brake apparatus continues boosting control of the wheel cylinders W/C with use of the pump motor PM according to the brake operation amount input by the driver at the time of occurrence of such a failure that the stroke of the brake pedal BP becomes excessive with respect to the master pressure compared to when the brake apparatus operates normally, due to, for example, a leak of the brake fluid from a pipe of the master cylinder M/C. The target hydraulic pressures of the wheel cylinders W/C are calculated from the respective values detected by the stroke sensor S1 and the master pressure sensor S2 similarly to when the brake apparatus operates normally. Therefore, the target hydraulic pressures are unaffected as long as the stroke S of the brake pedal BP or a master pressure Pmc is output. Therefore, the brake apparatus can perform the boosting control of the wheel cylinders W/C in a similar manner to when the brake apparatus operates normally, without affecting the wheel cylinder W/C pressures.

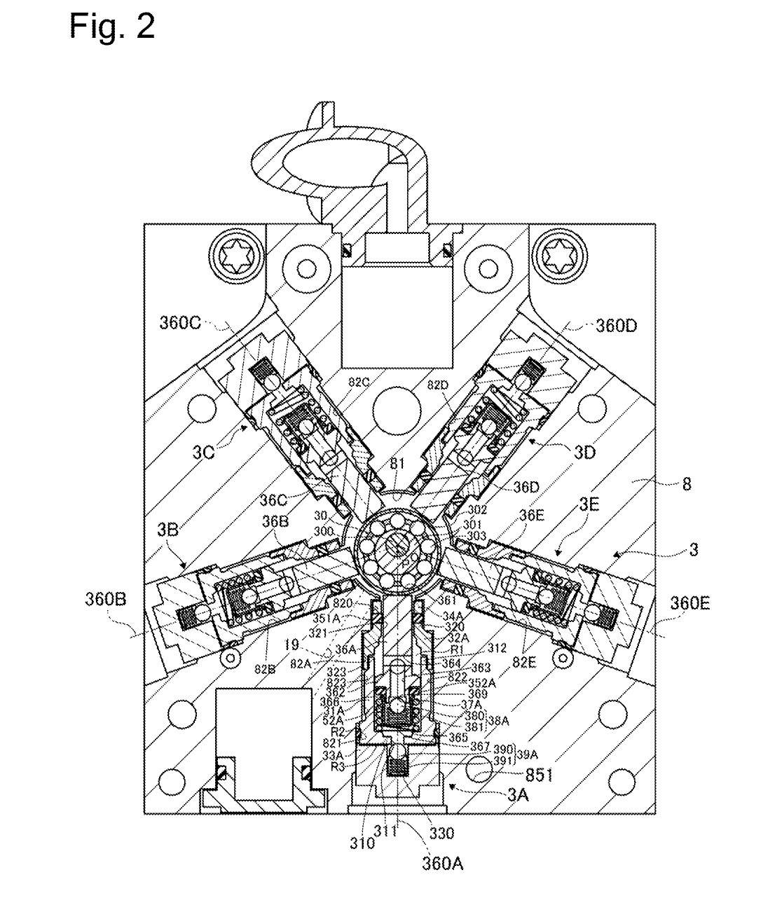

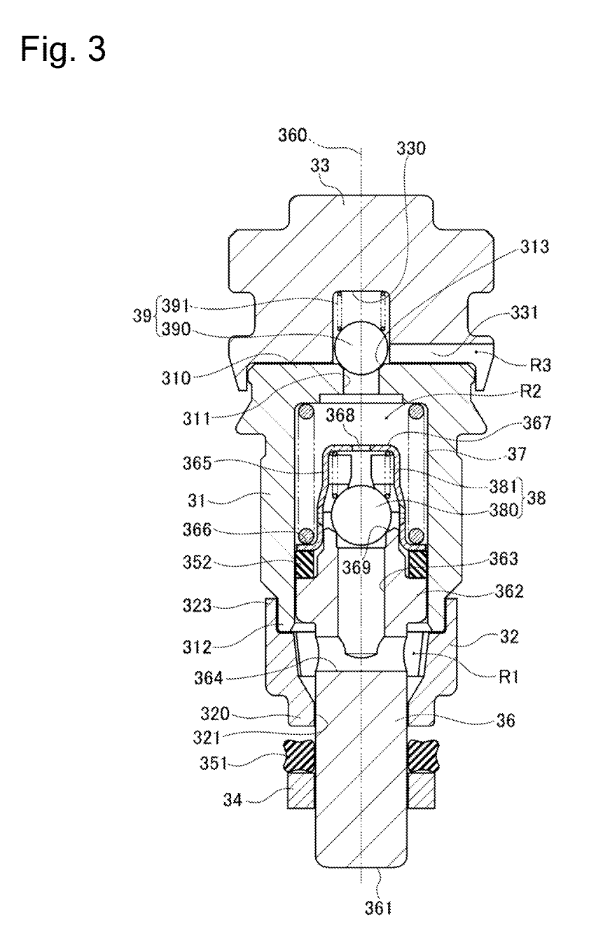

FIG. 2 is a cross-sectional view of the plunger pump according to the first embodiment. FIG. 3 is an enlarged cross-sectional view of the pump portion according to the first embodiment. A central axis (an axis) of a rotational shaft of the pump motor PM approximately coincides with a central axis O of a cam containing hole 81. A rotational driving shaft 300, which is a rotational shaft and a driving shaft of the plunger pump 3, and a cam unit 30 are contained in the cam containing hole 81. The rotational driving shaft 300 is the driving shaft of the plunger pump 3. The rotational driving shaft 300 is fixedly coupled with the rotational shaft of the pump motor PM in such a manner that a central axis thereof extends on an extension of the central axis of the rotational shaft of the pump motor PM, and is rotationally driven by the pump motor PM. The central axis of the rotational driving shaft 300 approximately coincides with the central axis O. The rotational driving shaft 300 rotates integrally with the rotational shaft of the pump motor PM around the central axis O. The cam unit 30 is provided at the rotational driving shaft 300. The cam unit 30 includes a cam 301, a driving member 302 (an outer race), and a plurality of rolling members 303. The cam 301 is a columnar eccentric cam, and has a central axis P eccentric with respect to the central axis O of the rotational driving shaft 300. The central axis P extends approximately in parallel with the central axis O. The cam 301 swings while rotating around the central axis O integrally with the rotational driving shaft 300. The driving member 302 (the outer race) has a cylindrical shape, and is disposed on an outer peripheral side of the cam 301. A central axis of the driving member 302 (the outer race) approximately coincides with the central axis P. The driving member 302 (the outer race) is rotatable around the central axis P relative to the cam 301. The driving member 302 (the outer race) is an eccentric bearing configured similarly to an outer race of a roller bearing. The plurality of rolling members 303 is disposed between an outer peripheral surface of the cam 301 and an inner peripheral surface of the driving member 302 (the outer race). The rolling members 303 are needle rollers, and extend along a direction of the central axis of the rotational driving shaft 300.

The plunger pump 3 is a radial plunger pump in the form of a fixed cylinder, and includes a housing 8, the rotational driving shaft 300, the cam unit 30, and a plurality of (five) pump portions 3A to 3E. The pump portions 3A to 3E are each a plunger pump (a piston pump) as a reciprocating pump, and are activated by the rotation of the rotational driving shaft 300. The brake fluid as hydraulic fluid is introduced and discharged according to reciprocating movements of plungers (pistons) 36. The cam unit 30 has a function of converting the rotational movement of the rotational driving shaft 300 into the reciprocating movements of the plungers 36. When a configuration of each of the pump portions 3A to 3E is distinguished from each other, indexes A to E are added to the reference numerals thereof. The individual plungers 36 are disposed around the cam unit 30, and are each contained in a cylinder containing hole 82. A central axis 360 of each of the plungers 36 approximately coincides with the central axis of the cylinder containing hole 82, and extends in a radial direction of the rotational driving shaft 300. In other words, the plungers 36 as many as the number of the cylinder containing holes 82 (five) are provided, and extend in a radial direction with respect to the central axis O. The plungers 36A to 36E are disposed approximately evenly in a direction around the rotational driving shaft 300 (hereinafter simply referred to as a circumferential direction), i.e., at approximately equal intervals in a direction in which the rotational driving shaft 300 rotates. Central axes 360A to 360E of these plungers 36A to 36E are located in the same plane. These plungers 36A to 36E are driven by the same rotational driving shaft 300 and the same cam unit 30.

The pump portion 3A includes a cylinder sleeve 31, a filter member 32, a plug 33, a guide ring 34, a first seal ring 351, a second seal ring 352, the plunger 36, a return spring 37, an intake valve 38, and a discharge valve 39, and these components are set in the cylinder containing hole 82. The cylinder sleeve 31 has a bottomed cylindrical shape, and a through-hole 311 penetrates through a bottom portion 310. The cylinder sleeve 31 is fixed in the cylinder containing hole 82. A central axis of the cylinder sleeve 31 approximately coincides with the central axis 360 of the cylinder containing hole 82. An end portion 312 of the cylinder sleeve 31 on an opening side is disposed at an intermediate-diameter portion 822 (an intake port 823), and the bottom portion 310 is disposed at a large-diameter portion (discharge port) 821. The filter member 32 has a bottomed cylindrical shape, and a hole 321 penetrates through a bottom portion 320 and a plurality of opening portions also penetrates through a side wall portion. A filter is set at each of these opening portions. An end portion 323 of the filter member 32 on an opening side is fixed to the end portion 312 of the cylinder sleeve 31 on the opening side. The bottom portion 320 is disposed at a small-diameter portion 820. A central axis of the filter member 32 approximately coincides with the central axis 360 of the cylinder containing hole 82. A gap is generated between an outer peripheral surface where the opening portion of the filter member 32 is opened and an inner peripheral surface of the cylinder containing hole 82 (the intake port 823). A first communication fluid passage is in communication with the intake port 823 and the above-described gap. The plug 33 has a columnar shape, and includes a bottomed cylindrical discharge chamber 330 and a discharge passage 331 on one end side in a direction of a central axis thereof. This discharge passage 331 extends radially to connect the discharge chamber 330 and an outer peripheral surface of the plug 33 to each other, and is in communication with the discharge port 821. The above-described one axial side of the plug 33 is fixed to the bottom portion 310 of the cylinder sleeve 31. The central axis of the plug 33 approximately coincides with the central axis 360 of the cylinder containing hole 82. The plug 33 is fixed to the large-diameter portion 821, and closes an opening of the cylinder containing hole 82 on an outer peripheral surface of the housing 8. A second communication fluid passage is in communication with the discharge port 821 and the above-described discharge passage 331 of the plug 33. The guide ring 34 has a cylindrical shape, and is fixed on the cam containing hole 81 side of the cylinder containing hole 82 with respect to the filter member 32 (the small-diameter portion 820). A central axis of the guide ring 34 approximately coincides with the central axis 360 of the cylinder containing hole 82. The first seal ring 351 is set between the guide ring 34 and the filter member 32 in the cylinder containing hole 82 (the small-diameter portion 820).

The plunger 36 has a columnar shape, and includes an end surface (hereinafter referred to as a plunger end surface) 361 on one side in a direction of the central axis thereof and a flange portion 362 on an outer periphery on an opposite side in the direction of the central axis thereof. The plunger end surface 361 has a flat shape extending in a direction generally perpendicular to the central axis 360 of the plunger 36, and has a generally circular shape centered at the central axis 360. The plunger 36 includes an axial hole 363 and a radial hole 364 therein. The axial hole 363 extends on the central axis 360 to be opened on an end surface of the plunger 36 on the above-described opposite side in the direction of the central axis. The radial hole 364 extends in a radial direction of the plunger 36 to be opened on an outer peripheral surface on the above-described one side in the direction of the central axis with respect to the flange portion 362 and to be also connected to the above-described one side of the axial hole 363 in the direction of the central axis. A check valve case 365 is fixed at an end portion of the plunger 36 on the above-described opposite side in the direction of the central axis. The check valve case 365 has a bottomed cylindrical shape made of a thin plate, and includes a flange portion 366 on an outer periphery of an end portion thereof on an opening side and a plurality of holes 368 penetrating through a side wall portion and a bottom portion 367 thereof. The end portion of the check valve case 365 on the opening side is fitted to the end portion of the plunger 36 on the above-described opposite side in the direction of the central axis. The second seal ring 352 is set between the flange portion 366 of the check valve case 365 and the flange portion 362 of the plunger 36. The above-described opposite side of the plunger 36 in the direction of the central axis is inserted in an inner peripheral side of the cylinder sleeve 31, and the flange portion 362 is guided and supported by the cylinder sleeve 31. The above-described one side of the plunger 36 in the direction of the central axis with respect to the radial hole 364 is inserted in an inner peripheral side (the hole 321) of the bottom portion 320 of the filter member 32, an inner peripheral side of the first seal ring 351, and an inner peripheral side of the guide ring 34, and is guided and supported by them. The central axis 360 of the plunger 36 approximately coincides with the central axis of the cylinder sleeve 31 and the like (the cylinder containing hole 82). The end portion of the plunger 36 on the above-describe one side in the direction of the central axis (the plunger end surface 361) protrudes to inside the cam containing hole 81.

The return spring 37 is a compression coil spring, and is set on the inner peripheral side of the cylinder sleeve 31. One end and an opposite end of the return spring 37 are set on the bottom portion 310 of the cylinder sleeve 31 and the flange portion 366 of the check valve case 365, respectively. The return spring 37 constantly biases the plunger 36 toward the cam containing hole 81 side relative to the cylinder sleeve 31 (the cylinder containing hole 82). The intake valve 38 includes a ball 380 as a valve body and a return spring 381, and they are contained on an inner peripheral side of the check valve case 365. A valve seat 369 is provided around the opening of the axial hole 363 on the end surface of the plunger 36 on the above-described opposite side in the direction of the central axis. The ball 380 is seated on the valve seat 369, by which the axial hole 363 is closed. The return spring 381 is a compression coil spring, and one end and an opposite end thereof are set on the bottom portion 367 of the check valve case 365 and the ball 380, respectively.

The return spring 381 constantly biases the ball 380 toward the valve seat 369 side relative to the check valve case 365 (the plunger 36). The discharge valve 39 includes a ball 390 as a valve body and a return spring 391, and they are contained in the discharge chamber 330 of the plug 33. A valve seat 313 is provided around an opening portion of the through-hole 311 on the bottom portion 310 of the cylinder sleeve 31. The ball 390 is seated on the valve seat 313, by which the through-hole 311 is closed. The return spring 391 is a compression coil spring, and one end and an opposite end thereof are set on a bottom surface of the discharge chamber 330 and the ball 390, respectively. The return spring 391 constantly biases the ball 390 toward the valve seat 313 side.

Inside the cylinder containing hole 82, a space R1 on the cam containing hole 81 side with respect to the flange portion 362 of the plunger 36 is a space on the intake side in communication with the first communication fluid passage. More specifically, a space extending from the above-described gap between the outer peripheral surface of the filter member 32 and the inner peripheral surface (the intake port 823) of the cylinder containing hole 82, passing through the plurality of openings of the filter member 32 and a gap between an outer peripheral surface of the plunger 36 and an inner peripheral surface of the filter member 32, and leading to the radial hole 364 and the axial hole 363 of the plunger 36 functions as the intake-side space R1. This intake-side space R1 is prevented from communicating with the cam containing hole 81 by the first seal ring 351.

Inside the cylinder containing hole 82, a space R3 between the cylinder sleeve 31 and the plug 33 is a discharge-side space in communication with the second communication fluid passage. More specifically, a space extending from the discharge passage 331 of the plug 33 to the discharge port 821 functions as the discharge-side space R3. On the inner peripheral side of the cylinder sleeve 31, a volume of a space R2 between the flange portion 362 of the plunger 36 and the bottom portion 310 of the cylinder sleeve 31 changes due to the reciprocation (the stroke) of the plunger 36 relative to the cylinder sleeve 31. This space R2 is in communication with the intake-side space R1 due to opening of the intake valve 38, and is in communication with the discharge-side space R3 due to opening of the discharge valve 39.

The plunger 36 of the pump portion 3A exerts a pump function by reciprocating. More specifically, when the plunger 36 is stroked to one side approaching the cam containing hole (the central axis O), the volume of the space R2 increases and a pressure in R2 reduces. Due to closing of the discharge valve 39 and the opening of the intake valve 38, the brake fluid as the hydraulic fluid is introduced from the intake-side space R1 to the space R2, and the brake fluid is supplied from the first communication fluid passage into the space R2 via the intake port 823. When the plunger 36 is stroked to the other side away from the cam containing hole 81, the volume of the space R2 reduces and the pressure in R2 increases. Due to closing of the intake valve 38 and the opening of the discharge valve 39, the brake fluid is transmitted out of the space R2 into the discharge-side space R3 by passing through the through-hole 311, and the brake fluid is supplied into the second communication fluid passage via the discharge port 821. The other pump portions 3B to 3E are also configured in a similar manner. The brake fluid discharged to the second communication fluid passage by each of the pump portions 3A to 3E is collected into the single discharge fluid passage 13, and is used in common by the two hydraulic circuit systems.

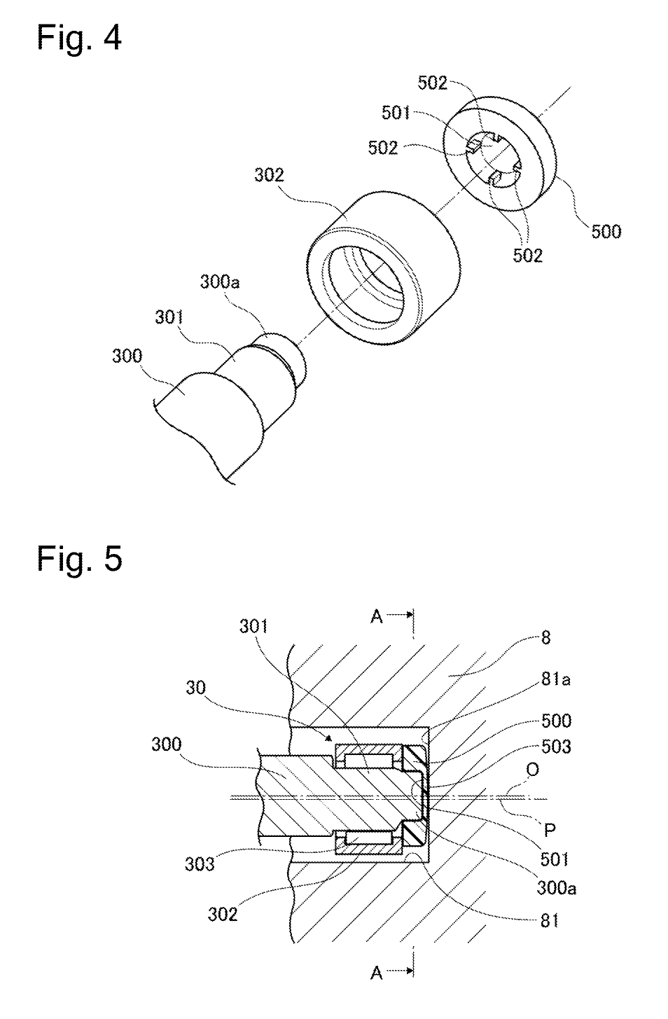

FIG. 4 is an exploded perspective view of the rotational driving shaft 300, the cam (the cam unit) 301, the driving member (the cam unit) 302, and a resin collar 500 according to the first embodiment. The illustration in FIG. 4 does not include the plurality of rolling members 303 in the driving member 302 (the outer race).

Then, as illustrated in FIG. 4, the columnar cam 301, which serves as an eccentric shaft having the central axis P eccentric with respect to the central axis O of the rotational driving shaft 300, is integrally formed at a distal end of the rotational driving shaft 300 as a rotational shaft configured to be rotationally driven by the pump motor PM, and a press fit portion 300a, which is press-fitted in the resin collar 500 as a sliding member including a sliding portion, is formed at a most distal end. This press fit portion 300a is cylindrically formed, and is fixedly press-fitted on four protrusions 502 formed on an inner peripheral surface of a press fit hole 501 formed as a bottomed hole in the resin collar 500 as the sliding member including the sliding portion. The press fit portion 300a may be fixedly press-fitted on the inner peripheral surface of the press fit hole 501 without the protrusions 502 provided. Further, a central axis of this press fit portion 300a is concentric with the central axis O of the rotational driving shaft 300.

FIG. 5 is a cross-sectional view of the rotational driving shaft 300, the cam (the cam unit) 301, the driving member (the cam unit) 302, and the resin collar 500 illustrated in FIG. 4 in a state mounted in the housing 8. As illustrated in FIG. 5, the columnar cam 301 as the eccentric shaft is disposed while penetrating through the cylindrical driving member 302 (the outer race) so as to contact the plurality of rolling members 303 disposed in the cylindrical driving member 302 (the outer race) as an eccentric cam that causes the plunger 36 to reciprocate. The cam unit 30 is formed by the cam 301, the driving member 302 (the outer race), and the plurality of rolling members 303. Further, a roller bearing is formed by the driving member 302 (the outer race) and the plurality of rolling members 303. The press fit portion 300a and the resin collar 500 as the sliding member including the sliding portion are fixed to each other in such a manner that the press fit portion 300a is fixedly press-fitted on the four protrusions 502 formed on the inner peripheral surface of the press fit hole 501 of the collar 500 as illustrated in FIG. 6, which is a cross-sectional view taken along a line A-A in FIG. 5. Further, a bottom surface portion 503 of the collar 500 is spherically formed, and is disposed so as to abut against a bottom portion 81a of the cam containing hole 81 as a stopper portion for preventing detachment of the driving member 302 (the outer race).

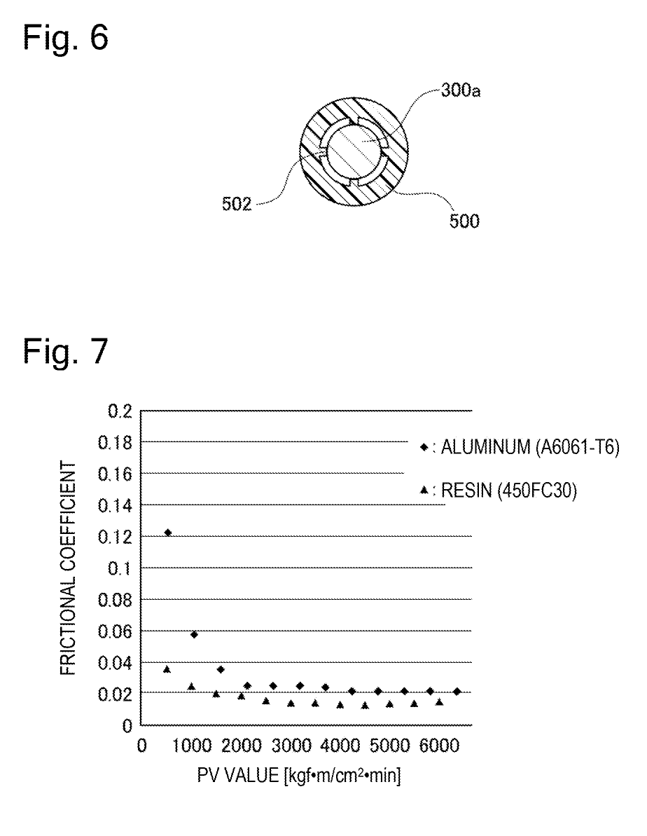

FIG. 7 illustrates a characteristic indicating a relationship between a material and a frictional coefficient according to the first embodiment.

FIG. 7 illustrates a frictional coefficient of each of aluminum (A6061-T6) used for the housing 8 and resin (450FC30) used for the collar 500. A horizontal axis represents a PV value, and a vertical axis represents the frictional coefficient. FIG. 7 indicates that the resin (450FC30) stably exhibits a low frictional coefficient, as the frictional coefficient of the resin (450FC30) is lower than the aluminum (A6061-T6) and is little changed with respect to a change in the PV value in all PV value regions. Due to this characteristic, the frictional coefficient can be reduced to a low value between contact surfaces as the sliding portion between the driving member 302 (the outer race) as the eccentric cam and the resin collar 500 as the sliding member. Further, the low frictional coefficient can also be achieved regarding a sliding movement between the bottom surface portion 503 of the collar 500 and the bottom portion 81a of the cam containing hole 81 as the stopper portion for preventing the detachment of the driving member 302 (the outer race).

Next, functions and effects will be described. The pump apparatus and the brake apparatus according to the first embodiment fulfill functions and effects that will be listed below.

(1) The frictional coefficient can be reduced between the driving member 302 (the outer race) as the eccentric cam and the resin collar 500 as the sliding member including the sliding portion, and therefore co-rotation between these components can be prevented or reduced. Therefore, wear can be prevented or reduced on the end surface of the plunger (the piston) 36 of the plunger pump 3 and the driving member 302 (the outer race) as the eccentric cam in abutment therewith. Further, according thereto, quietness as the plunger pump 3 can also be improved.

(2) The low frictional coefficient can also be achieved regarding the sliding portion between the resin collar 500 as the sliding member including the sliding portion and the bottom portion 81a of the cam containing hole 81 as the stopper portion for preventing the detachment of the driving member 302 (the outer race). Therefore, wear of the collar 500 on the bottom portion 81a side of the cam containing hole 81 can also be prevented or reduced, and therefore durability of the plunger pump 3 can be improved.

(3) The first embodiment is configured in such a manner that the resin collar 500 is brought into abutment with the bottom portion 81a of the cam containing hole 81 as the stopper portion for preventing the detachment of the driving member 302 (the outer race). Therefore, the present configuration eliminates a necessity of providing the stopper portion with a different member, leading to a reduction in the number of components. Further, the resin collar 500 as the sliding member including the sliding portion can also play a role of preventing the detachment of the driving member 302 (the outer race) as the eccentric cam even by itself.

(4) The bottom surface portion 503 of the resin collar 500 as the sliding member including the sliding portion is spherically formed, and can abut against the bottom portion 81a of the cam containing hole 81 of the housing 8 as the stopper portion. Further, the bottom portion 503 is in point or line contact with the bottom portion 81a of the cam containing hole 81 of the housing 8, and therefore the friction can be further reduced.

(5) The resin collar 500 as the sliding member including the sliding portion is partially in abutment with the outer periphery of the columnar cam 301, which is the eccentric shaft. Therefore, the attachment of the resin collar 500 is satisfactory as long as the resin collar 500 is held just enough to prevent the driving member 302 (the outer race) from being detached from the collar 301, and therefore a load of the press fit can be reduced.

(6) The driving member 302 (the outer race) and the plurality of rolling members 303 form the roller bearing. Therefore, a frictional torque with the cam 301 can be reduced.

### Second Embodiment

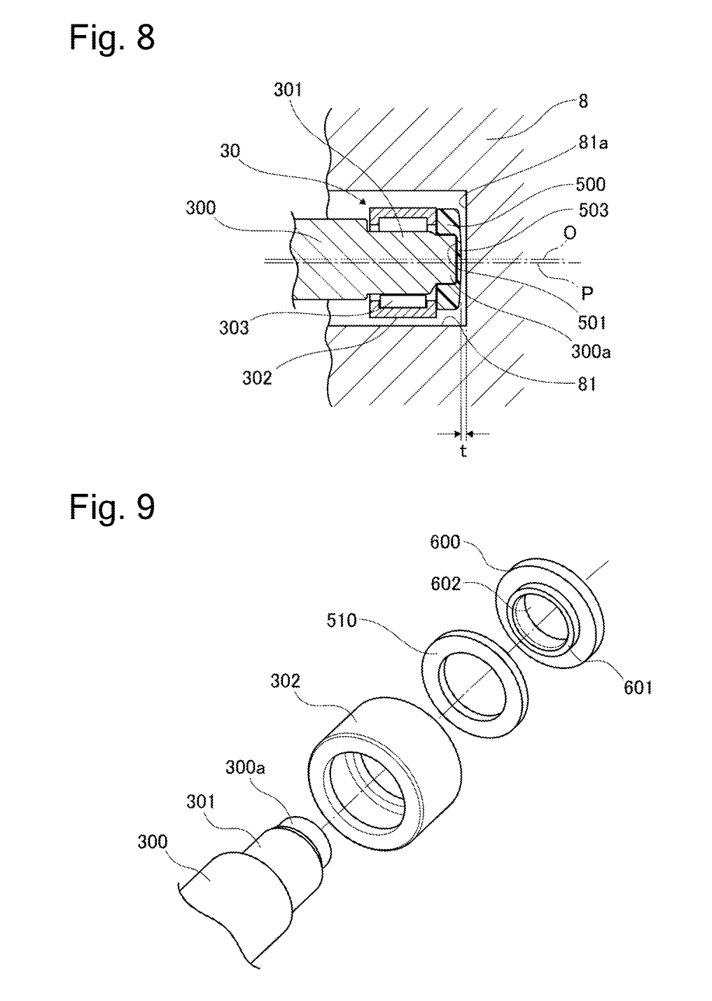

FIG. 8 is a cross-sectional view illustrating the rotational driving shaft 300, the cam (the cam unit) 301, the driving member (the cam unit) 302, and the resin collar 500 in the state mounted in the housing 8 according to a second embodiment. The illustration in FIG. 8 does not include the plurality of rolling members 303 in the driving member 302 (the outer race). Unlike the first embodiment, the bottom surface portion 503 of the collar 500 is disposed with a predetermined gap t generated from the bottom portion 81a of the cam containing portion 81 as the stopper portion for preventing the detachment of the driving member 302 (the outer race). The other configuration is similar to the first embodiment, and therefore components shared with the first embodiment will be identified by the same reference numerals as the first embodiment and descriptions thereof will be omitted below.

Next, functions and effects will be described. The bottom surface portion 503 of the collar 500 as the sliding member including the sliding portion is disposed with the predetermined gap t generated from the bottom portion 81a of the cam containing portion 81 as the stopper portion. Therefore, the friction can be reduced because the bottom surface portion 503 is not constantly in contact with the bottom portion 81a. Hypothetically even if the collar 500 is axially displaced and the bottom surface portion 503 abuts against the bottom portion 81a, the spherical shape of the bottom surface portion 503 can allow them to have a point or line contact therebetween, thereby reducing the friction. Other functions and effects are similar to the first embodiment.

### Third Embodiment

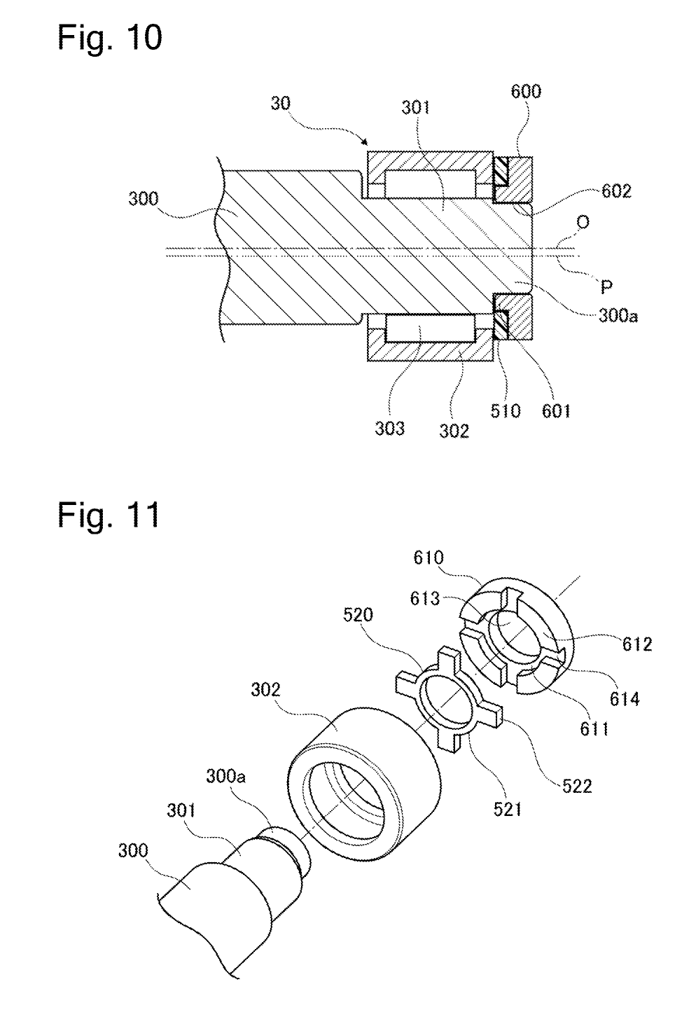

FIG. 9 is an exploded perspective view of the rotational driving shaft 300, the cam (the cam unit) 301, the driving member (the cam unit) 302, a resin collar 510, and a metallic stopper member 600 according to a third embodiment. The illustration in FIG. 9 does not include the plurality of rolling members 303 in the driving member 302 (the outer race). FIG. 10 is a cross-sectional view of the rotational driving shaft 300, the cam (the cam unit) 301, the driving member (the cam unit) 302, the resin collar 510, and the metallic stopper member 600 in an assembled state according to the third embodiment. Unlike the first embodiment, the metallic stopper member 600, which is a separate member, is provided as the stopper portion for preventing the detachment of the driving member 302 (the outer race). A stepped portion 601 protruding to the driving member 302 side is provided on the driving member 302 (the outer race) side of the stopper member 600. The ring-shaped resin collar 510 as the sliding member including the sliding portion is attached and disposed on the stepped portion 601. The press fit portion 300a at the distal end of the rotational driving shaft 300 is press-fitted in a central press fit hole 602, and they are fixed to each other. The other configuration is similar to the first embodiment, and therefore components shared with the first embodiment will be identified by the same reference numerals as the first embodiment and descriptions thereof will be omitted below.

Next, functions and effects will be described.

(1) The frictional coefficient can be reduced between the driving member 302 (the outer race) as the eccentric cam and the resin collar 510 as the sliding member including the sliding portion, and therefore co-rotation between these components can be prevented or reduced. Therefore, the wear can be prevented or reduced on the end surface of the plunger (the piston) 36 of the plunger pump 3 and the driving member 302 (the outer race) as the eccentric cam in abutment therewith. Further, according thereto, the quietness as the plunger pump 3 can also be improved.

(2) The metallic stopper member 600, which is the separate member, is provided as the stopper portion for preventing the detachment of the driving member 302 (the outer race). Therefore, due to the provision of the stopper member 600 as the separate member, the present configuration can ensure that the resin collar 510 which is the sliding member including the sliding portion is prevented from being detached. Further, the friction can be reduced due to absence of the abutment with the bottom portion 81a of the cam containing hole 81 of the housing 8.

(3) The stepped portion 601 protruding to the driving member 302 side is provided on the driving member 302 (the outer race) side of the stopper member 600. The resin collar 510 as the sliding member including the sliding portion is attached and disposed on an outer periphery of the stepped portion 601. A length of the press fit hole 602 can be increased by an amount corresponding to this stepped portion 601. Therefore, the present configuration can secure a press fit allowance of the stopper member 600, thereby ensuring that the resin collar 510 is prevented from being detached.

(4) The driving member 302 (the outer race) and the plurality of rolling members 303 form the roller bearing. Therefore, the frictional torque with the cam 301 can be reduced.

### Fourth Embodiment

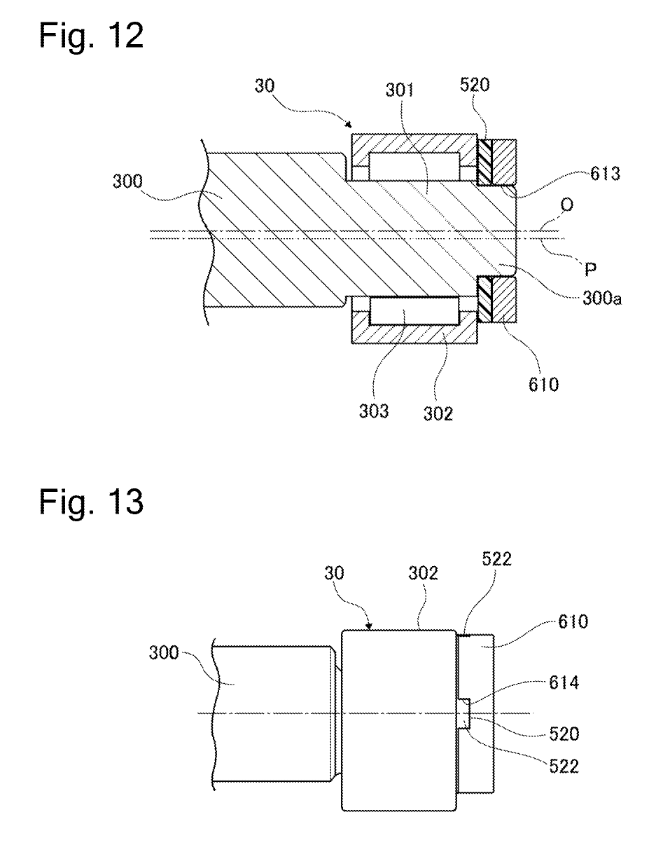

FIG. 11 is an exploded perspective view of the rotational driving shaft 300, the cam (the cam unit) 301, the driving member (the cam unit) 302, a resin collar 520, and a metallic stopper member 610 according to a fourth embodiment. The illustration in FIG. 11 does not include the plurality of rolling members 303 in the driving member 302 (the outer race). FIG. 12 is a cross-sectional view of the rotational driving shaft 300, the cam (the cam unit) 301, the driving member (the cam unit) 302, the resin collar 520, and the metallic stopper member 610 in an assembled state according to the fourth embodiment. FIG. 13 is a plan view of the rotational driving shaft 300, the cam (the cam unit) 301, the driving member (the cam unit) 302, the resin collar 520, and the metallic stopper member 610 in the assembled state according to the fourth embodiment. Unlike the first embodiment, the metallic stopper member 610, which is a separate member, is provided as the stopper portion for preventing the detachment of the driving member 302 (the outer race). A ring-shaped central recessed portion 611 and a ring-shaped stepped portion 612 are provided with four radial recessed portions 614 provided at the ring-shaped stepped portion 612 on the driving member 302 (the outer race) side of the stopper member 610. The press fit portion 300a at the distal end of the rotational driving shaft 300 is press-fitted in a central press fit hole 613, and they are fixed to each other. Further, the resin collar 520 is provided with four protrusions 522 protruding from a ring-shaped main body portion 521 radially outward. The resin collar 520 and the stopper member 610 are assembled with the ring-shaped main body portion 521 and the four protrusions 522 of the resin collar 520 inserted in the central recessed portion 611 and the four radial recessed portions 612 of the ring-shaped stepped portion 612 of the metallic stopper member 610, respectively. An axial thickness of the resin collar 520 and axial thicknesses of the central recessed portion 611 and the four radial recessed portions 612 of the ring-shaped stepped portion 612 of the metallic stopper member 610 are approximately equal to each other. Both the resin collar 520 and the metallic stopper member 610 are in contact with the driving member 302 (the outer race). The other configuration is similar to the first embodiment, and therefore components shared with the first embodiment will be identified by the same reference numerals as the first embodiment and descriptions thereof will be omitted below.

Next, functions and effects will be described.

(1) The frictional coefficient can be reduced between the driving member 302 (the outer race) as the eccentric cam and the resin collar 520 as the sliding member including the sliding portion, and therefore co-rotation between these components can be prevented or reduced. Therefore, the wear can be prevented or reduced on the end surface of the plunger (the piston) 36 of the plunger pump 3 and the driving member 302 (the outer race) as the eccentric cam in abutment therewith. Further, according thereto, the quietness as the plunger pump 3 can also be improved.

(2) The metallic stopper member 610, which is the separate member, is provided as the stopper portion for preventing the detachment of the driving member 302 (the outer race). Therefore, due to the provision of the stopper member 610 as the separate member, the present configuration can ensure that the resin collar 520 which is the sliding member is prevented from being detached. Further, the friction can be reduced due to the absence of the abutment with the bottom portion 81a of the cam containing hole 81 of the housing 8.

(3) The resin collar 520 and the stopper member 610 are assembled with the main body portion 521 and the four protrusions 522 of the resin collar 520 inserted in the central recessed portion 611 and the four radial recessed portions 614 of the ring-shaped stepped portion 612 of the metallic stopper member 610, respectively. Therefore, the present configuration can achieve both wear resistance due to the resin collar 520 and durability due to the metallic stopper member 610.

(4) The driving member 302 (the outer race) and the plurality of rolling members 303 form the roller bearing. Therefore, the frictional torque with the cam 301 can be reduced.

(5) On the surface on the driving member 302 (the outer race) side, the resin collar 520 and the metallic stopper member 610 are located in the same plane and both the resin collar 520 and the metallic stopper member 610 are in abutment with the driving member 302 (the outer race). Therefore, the present configuration can achieve both the wear resistance due to the resin collar 520 and the durability due to the metallic stopper member 610.

### Fifth Embodiment

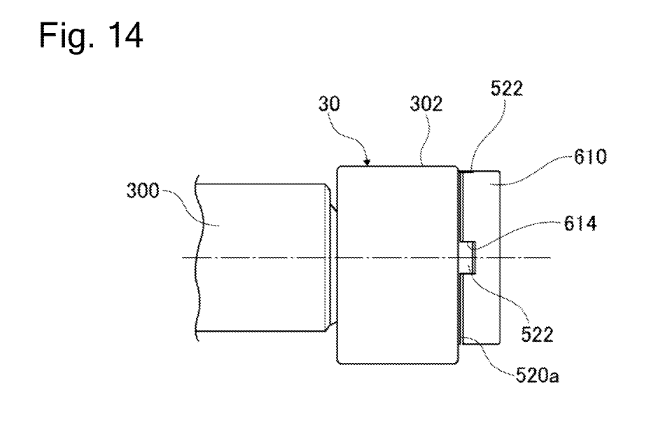

FIG. 14 is a plan view of the rotational driving shaft 300, the cam (the cam unit) 301, the driving member (the cam unit) 302, a resin collar 520a, and the metallic stopper member 610 in an assembled state according to a fifth embodiment. Unlike the fourth embodiment, an axial thickness of the resin collar 520a is greater than the axial thicknesses of the central recessed portion 611 and the four radial recessed portions 614 of the ring-shaped stepped portion 612 of the metallic stopper member 610. The other configuration is similar to the fourth embodiment, and therefore components shared with the fourth embodiment will be identified by the same reference numerals as the fourth embodiment and descriptions thereof will be omitted below.

Next, functions and effects will be described. Only the resin collar 520a is in abutment with the driving member 302 (the outer race), and therefore the friction can be reduced and the wear can be prevented or reduced on the end surface of the plunger (the piston) 36 of the plunger pump 3 and the driving member 302 (the outer race) as the eccentric cam in abutment therewith. Further, according thereto, the quietness as the plunger pump 3 can also be improved. If the resin collar 520a is worn and both the resin collar 520a and the metallic stopper member 610 are brought into contact with the driving member 302 (the outer race) as the eccentric cam, the present configuration can achieve both the wear resistance due to the resin collar 520a and the durability due to the metallic stopper member 610. Further, because sliding noise is different between when only the resin collar 520a is in abutment with the driving member 302 (the outer race) and both the resin collar 520a and the metallic stopper member 610 are brought into contact with the driving member 302 (the outer race), the present configuration makes it possible to confirm a state of the wear of the resin collar 520a.

### Other Embodiments

Having described the present invention based on each of the embodiments thereof, even another configuration is also included in the present invention. For example, in each of the embodiments, the sliding member low in frictional coefficient is provided as the separate member as the resin collar, but the bottom portion 81a of the cam containing hole 81 or the metallic stopper member 600 or 610 may be coated (subjected to surface processing) with a low frictional material. Further, the stopper portion has been described referring to the cam containing hole 81 or the metallic stopper member 600 or 610, but may be molded integrally with the sliding member with use of resin. The above-described embodiments include the roller bearing formed by the driving member 302 (the outer race) and the plurality of rolling members 303, but a ball bearing, a sliding bearing, or the like may also be applied. The cam 301, which is the eccentric shaft, may be directly formed on the rotational driving shaft 300 or may be provided by attaching another member.

In the following description, other configurations recognizable from the above-described embodiments will be described. A pump apparatus and a brake apparatus, according to one configuration thereof, include a motor, a rotational shaft configured to be rotationally driven by the motor, an eccentric shaft having a central axis eccentric with respect to a central axis of the rotational shaft and configured in such a manner that the eccentric central axis is rotated around the central axis of the rotational shaft by the rotation of the rotational shaft, an eccentric cam disposed around the eccentric shaft and configured to swing around the eccentric central axis by the rotation of the eccentric shaft, a plunger pump disposed around the eccentric cam and configured to exert a pump function by reciprocating according to the swinging movement of the eccentric cam in such a manner that a direction perpendicular to the eccentric central axis is set as an operation axis direction, a stopper portion configured to limit a movement of the eccentric cam in a direction of the eccentric central axis, and a sliding portion provided between the stopper portion and the eccentric cam in the direction of the eccentric central axis and having a lower frictional coefficient between the sliding portion and the eccentric cam than a frictional coefficient between the stopper portion and the eccentric cam. According to a further preferable configuration, in the above-described configuration, a frictional coefficient between the sliding portion and the stopper portion is lower than the frictional coefficient between the stopper portion and the eccentric cam. According to further another preferable configuration, any of the above-described configurations further includes a housing including a surface on which the motor is mounted and a bottomed containing hole provided on an inner side with respect to the surface and containing the eccentric cam. The sliding portion is held by the eccentric shaft as a sliding member separate from the stopper portion. The stopper portion is a bottom portion of the containing hole. According to further another preferable configuration, in any of the above-described configurations, one side of the sliding member that faces the bottom portion of the containing hole is spherical. According to further another preferable configuration, in any of the above-described configurations, the sliding member is in abutment with the bottom portion of the containing hole. According to further another preferable configuration, in any of the above-described configurations, a predetermined gap is generated between the sliding member and the bottom portion of the containing hole. According to further another preferable configuration, in any of the above-described configurations, the sliding member is partially in abutment with an outer periphery of the eccentric shaft. According to further another preferable configuration, in any of the above-described configurations, the stopper portion is a stopper member which is fixed to the eccentric shaft and separate from a housing of the pump apparatus. According to further another preferable configuration, in any of the above-described configurations, the stopper member includes a stepped portion fixed to the eccentric shaft and formed by reducing a diameter of a portion on the eccentric cam side in the direction of the eccentric central axis. The sliding portion is configured as a sliding member separate from the stopper portion. The sliding member is disposed in the stepped portion. According to further another preferable configuration, in any of the above-described configurations, the stopper portion includes a recessed portion fixed to the eccentric shaft and formed on the eccentric cam side in the direction of the eccentric central axis. The sliding portion is configured as a sliding member separate from the stopper portion. The sliding member is disposed in the recessed portion. According to further another preferable configuration, in any of the above-described configurations, both the sliding member and the stopper portion are in abutment with the eccentric cam in the direction of the eccentric central axis. According to further another preferable configuration, in any of the above-described configurations, only the sliding member out of the sliding member and the stopper portion is in abutment with the eccentric cam in the direction of the eccentric central axis.

Having described several embodiments of the present invention, the above-described embodiments of the present invention are intended to only facilitate the understanding of the present invention, and are not intended to limit the present invention thereto. The present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2016-200571 filed on Oct. 12, 2016. The entire disclosure of Japanese Patent Application No. 2016-200571 filed on Oct. 12, 2016 including the specification, the claims, the drawings, and the abstract is incorporated herein by reference in its entirety.

### REFERENCE SIGNS LIST

M/C master cylinder
PM pump motor (actuator)
RSV reservoir tank
SS stroke simulator
W/C wheel cylinder
3 plunger pump
31 cylinder sleeve
33 plug (plug member)
33a recessed portion
36 plunger (piston)
39 discharge valve
8 housing
81a bottom portion of cam containing hole (stopper portion)
300 rotational driving shaft (rotational shaft)
301 cam (eccentric shaft)
302 driving member (eccentric cam)
330 discharge chamber
331 discharge passage
390 ball (ball valve)
500 resin collar (sliding member as sliding portion)
510 resin collar (sliding member as sliding portion)
520 resin collar (sliding member as sliding portion)
520a resin collar (sliding member as sliding portion)
600 metallic stopper member (stopper portion)
610 metallic stopper member (stopper portion)

1. A pump apparatus comprising:
a motor;
a rotational shaft configured to be rotationally driven by the motor;
an eccentric shaft having a central axis eccentric with respect to a central axis of the rotational shaft and configured in such a manner that the eccentric central axis is rotated around the central axis of the rotational shaft by the rotation of the rotational shaft;
an eccentric cam disposed around the eccentric shaft, and configured to swing around the eccentric central axis by the rotation of the eccentric shaft;
a plunger pump disposed around the eccentric cam, and configured to exert a pump function by reciprocating according to the swinging movement of the eccentric cam in such a manner that a direction perpendicular to the eccentric central axis is set as an operation axis direction;
a stopper portion configured to limit a movement of the eccentric cam in a direction of the eccentric central axis; and
a sliding portion provided between the stopper portion and the eccentric cam in the direction of the eccentric central axis, and having a lower frictional coefficient between the sliding portion and the eccentric cam than a frictional coefficient between the stopper portion and the eccentric cam.

2. The pump apparatus according to claim 1, wherein a frictional coefficient between the sliding portion and the stopper portion is lower than the frictional coefficient between the stopper portion and the eccentric cam.

3. The pump apparatus according to claim 1, further comprising a housing including a surface on which the motor is mounted, and a bottomed containing hole provided on an inner side with respect to the surface and containing the eccentric cam,
wherein the sliding portion is held by the eccentric shaft as a sliding member separate from the stopper portion, and
wherein the stopper portion is a bottom portion of the containing hole.

4. The pump apparatus according to claim 3, wherein one side of the sliding member that faces the bottom portion of the containing hole is spherical.

5. The pump apparatus according to claim 4, wherein the sliding member is in abutment with the bottom portion of the containing hole.

6. The pump apparatus according to claim 4, wherein a predetermined gap is generated between the sliding member and the bottom portion of the containing hole.

7. The pump apparatus according to claim 3, wherein the sliding member is partially in abutment with an outer periphery of the eccentric shaft.

8. The pump apparatus according to claim 1, wherein the stopper portion is a stopper member which is fixed to the eccentric shaft and separate from a housing of the pump apparatus.

9. The pump apparatus according to claim 8, wherein the stopper member includes a stepped portion fixed to the eccentric shaft and formed by reducing a diameter of a portion on the eccentric cam side in the direction of the eccentric central axis,
wherein the sliding portion is configured as a sliding member separate from the stopper portion, and
wherein the sliding member is disposed in the stepped portion.

10. The pump apparatus according to claim 8, wherein the stopper portion includes a recessed portion fixed to the eccentric shaft and formed on the eccentric cam side in the direction of the eccentric central axis,
wherein the sliding portion is configured as a sliding member separate from the stopper portion, and
wherein the sliding member is disposed in the recessed portion.

11. The pump apparatus according to claim 10, wherein both the sliding member and the stopper portion are in abutment with the eccentric cam in the direction of the eccentric central axis.

12. The pump apparatus according to claim 10, wherein only the sliding member out of the sliding member and the stopper portion is in abutment with the eccentric cam in the direction of the eccentric central axis.

13. The brake apparatus according to claim 1, wherein the eccentric cam is a roller bearing including
a plurality of rolling members provided on an outer periphery of the eccentric shaft, and
an outer race provided on an outer side in a radial direction of the eccentric shaft with respect to the plurality of rolling members.

14. A pump apparatus comprising:
a plunger pump;
an eccentric cam configured to drive the plunger pump;
a stopper portion provided in a direction of a swinging axis of the eccentric cam; and
a sliding portion provided between the stopper portion and the eccentric cam in the direction of the swinging axis, and having a lower frictional coefficient between the sliding portion and the eccentric cam than a frictional coefficient between the stopper portion and the eccentric cam.

15. The pump apparatus according to claim 14, wherein a frictional coefficient between the sliding portion and the stopper portion is lower than the frictional coefficient between the stopper portion and the eccentric cam.

16. A brake apparatus comprising:
a housing including a fluid passage;
a plunger pump provided inside the housing and configured to discharge brake fluid to the fluid passage;
a motor configured to drive the plunger pump and mounted on a surface of the housing;
a rotational shaft configured to be rotationally driven by the motor, and disposed in a bottomed containing hole provided on an inner side with respect to the surface of the housing;
an eccentric shaft having a central axis eccentric with respect to a central axis of the rotational shaft and configured in such a manner that the eccentric central axis is rotated around the central axis of the rotational shaft by the rotation of the rotational shaft;
an eccentric cam disposed around the eccentric shaft and configured to swing around the eccentric central axis by the rotation of the eccentric shaft to drive the plunger pump;
a stopper portion configured to limit a movement of the eccentric cam in a direction of the eccentric central axis; and
a sliding portion provided between the stopper portion and the eccentric cam in the direction of the eccentric central axis, and having a lower frictional coefficient between the sliding portion and the eccentric cam than a frictional coefficient between the stopper portion and the eccentric cam.

17. The brake apparatus according to claim 16, wherein a frictional coefficient between the sliding portion and the stopper portion is lower than the frictional coefficient between the stopper portion and the eccentric cam.

18. The brake apparatus according to claim 16, comprising the housing including the surface on which the motor is mounted, and the bottomed containing hole provided on the inner side with respect to the surface and containing the eccentric cam,
wherein the sliding portion is held by the eccentric shaft as a sliding member separate from the stopper portion, and
wherein the stopper portion is a bottom portion of the containing hole.

19. The brake apparatus according to claim 18, wherein the sliding member is partially in abutment with an outer periphery of the eccentric shaft.

20. The brake apparatus according to claim 16, wherein the stopper portion is a stopper member which is fixed to the eccentric shaft and separate from the housing.
